(19) United States
(12) Patent Application Publication
(10) Pub. No.: US 2002/0147894 A1
(43) Pub. Date: Oct. 10, 2002

(54) Program-controlled unit

(76) Inventors: Jens Barrenscheen, Munchen (DE); Karl Herz, Munchen (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/116,173

(22) Filed: Apr. 4, 2002

(30) Foreign Application Priority Data
Apr. 4, 2001 (DE) 101 16 862.4

(51) Int. Cl. G06F 12/00

(52) U.S. Cl. 711/155

(57) ABSTRACT

A description is given of a program-controlled unit, having a CPU and a memory management device. The memory management device, which, at the instigation of the CPU, writes data output by the CPU to a memory device, or reads out data stored in the memory device and forwards them to the CPU. The program-controlled unit described is distinguished by the fact that a control device is provided, which prescribes at least in part the instants at which the memory management device has to perform the actions required for carrying out a data transfer. What can thus be achieved is that, in phases in which the program-controlled unit uses a different memory device instead of a normally used memory device, the program-controlled unit behaves in precisely the same way as would be the case if the program-controlled unit currently used the normally used memory device.

### BACKGROUND OF THE INVENTION

1. Field of the Invention

The present invention relates to a program-controlled unit, having a CPU, and a memory management device, which, at the instigation of the CPU, writes data output by the CPU to a memory device, or reads out data stored in the memory device and forwards them to the CPU.

The program-controlled units are a microprocessor, a microcontroller, a signal processor or the like. Such program-controlled units have been known in innumerable embodiments for many years and need no further explanation.

The above-mentioned memory management device accepts from the CPU the actions that are to be carried out in order to write data to the memory device or read data from the memory device.

The burden on the CPU is noticeably relieved as a result in particular when a slowly operating memory device is involved. It has to communicate to the memory management device only the information as to whether data are intended to be read from the memory device or written to the memory device, the address which is intended to be accessed, and if appropriate the data to be stored, and can then continue to operate without waiting for the end of the access. Furthermore, the CPU also need not concern itself with the particulars to be taken into account in the event of an access to the memory device. It is solely incumbent upon the memory management device to determine from the address of the memory device which is intended to be accessed (a plurality of memory devices may be connected to the memory management device), to output to the relevant memory device the address from which data are intended to be read or to which data are intended to be written, to output the data to be stored, or to fetch the data to be read, and if data should be read from the memory device, to forward the data to the CPU.

The provision of the memory management device also proves to be advantageous if the program-controlled unit is a program-controlled unit which can be used in an emulator and in the case of which, during the emulation, a different memory device, generally referred to as an overlay memory, can be used instead of the memory device which is used in normal operation of the program-controlled unit. The changeover from the normally used memory device to the overlay memory can then be effected in a simple manner by changing, in the memory management device, the assignment which defines the memory device which must be accessed in order to execute the write or read operation requested by the CPU.

### SUMMARY OF THE INVENTION

It is accordingly an object of the invention to provide a program-controlled unit which overcomes the above-mentioned disadvantages of the prior art devices of this general type, in which the program-controlled unit uses a different memory device instead of a normally used memory device. The program-controlled unit behaves in precisely the same way as would be the case if the program-controlled unit currently used the normally used memory device.

With the foregoing and other objects in view there is provided, in accordance with the invention, a program-controlled unit. The program-controlled unit contains a CPU, a memory device, and a memory management device connected to the CPU and to the memory device. The memory management device at an instigation of the CPU, writes data output by the CPU to the memory device or reads out the data stored in the memory device and forwards the data to the CPU. A control device is connected to the memory management device. The control device prescribes at least in part instants at which the memory management device has to perform actions required for carrying out a data transfer.

The program-controlled unit according to the invention is distinguished by the fact that a control device is provided, which prescribes at least in part the instants at which the memory management device has to perform the actions required for carrying out a data transfer.

What can thus be achieved is that—apart from the content of the data obtained—from the point of view of the CPU there is no difference in respect of whether the normally used memory device or a different memory device is accessed.

Apart from this, the accesses to the memory device can thus also be affected more rapidly than is the case without the claimed control device. This is because of the obviation of the need, before the respective action is carried out, to await and evaluate signals that are output by the memory device and by which the memory device signals that it is ready to carry out the relevant action.

In accordance with an added feature of the invention, the control device prescribes an instant at which the memory management device can address the memory device again in an event of repeated accesses to the memory device.

In accordance with another feature of the invention, the control device prescribes an instant at which the memory management device can output the data that are to be written to the memory device.

In accordance with an additional feature of the invention, the control device prescribes an instant at which the memory management device can fetch previously requested data from the memory device.

In accordance with a further feature of the invention, the control device prescribes an instant at which the memory management device forwards the data read from the memory device to the CPU.

In accordance with a further added feature of the invention, the memory management device forwards the data read from the memory device to the CPU at least in part not until at a later time than it could do.

In accordance with a further additional feature of the invention, the instants at which the memory management device has to the perform actions required for carrying out the data transfer are defined independently of control signals output by the memory device in order to signal that a specific action can now be executed.

In accordance with another added feature of the invention, the CPU informs the memory management device of a memory address to which a memory access that is to be carried out has to be affected.

In accordance with another additional feature of the invention, the memory device is one of a plurality of memory devices connected to the memory management device, and the memory management device contains an assignment specification which defines, independently of an address fed to the memory management device by the CPU, which of the memory devices must be accessed by the memory management device.

In accordance with an added feature of the invention, the assignment specification is variable, so that the memory management device accesses a different one of the memory devices than is normally the case.

In accordance with an additional feature of the invention, the different one of the memory devices is a memory device that has other properties or must be communicated with differently than is the case with a respective memory device normally used.

In accordance with a further feature of the invention, the control device ensures that, apart from a content of the data obtained, from a point of view of the CPU there is no difference in respect of whether a normally used memory device or the different one of the memory devices is accessed.

In accordance with another feature of the invention, the control device ensures that the data read from the different one of the memory devices are forwarded to the CPU exactly at an instant as would be the case if the data had been read from the normally used memory device.

In accordance with a different feature of the invention, an emulator control unit is connected to the program-controlled unit, and the assignment specification is altered at an instigation of the emulator control unit.

In accordance with a concomitant feature of the invention, the different one of the memory devices which is used instead of a normally used memory device in response to an alteration of the assignment specification is an overlay memory in which there is stored a program which is to be executed for emulation purposes instead of a program stored in the normally used program memory.

Other features which are considered as characteristic for the invention are set forth in the appended claims.

Although the invention is illustrated and described herein as embodied in a program-controlled unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a configuration containing a conventional program-controlled unit; and

FIG. 2 is a block diagram of a configuration containing a program-controlled unit according to the invention.

### DESCRIPTION OF THE PREFERRED EMBODIMENTS

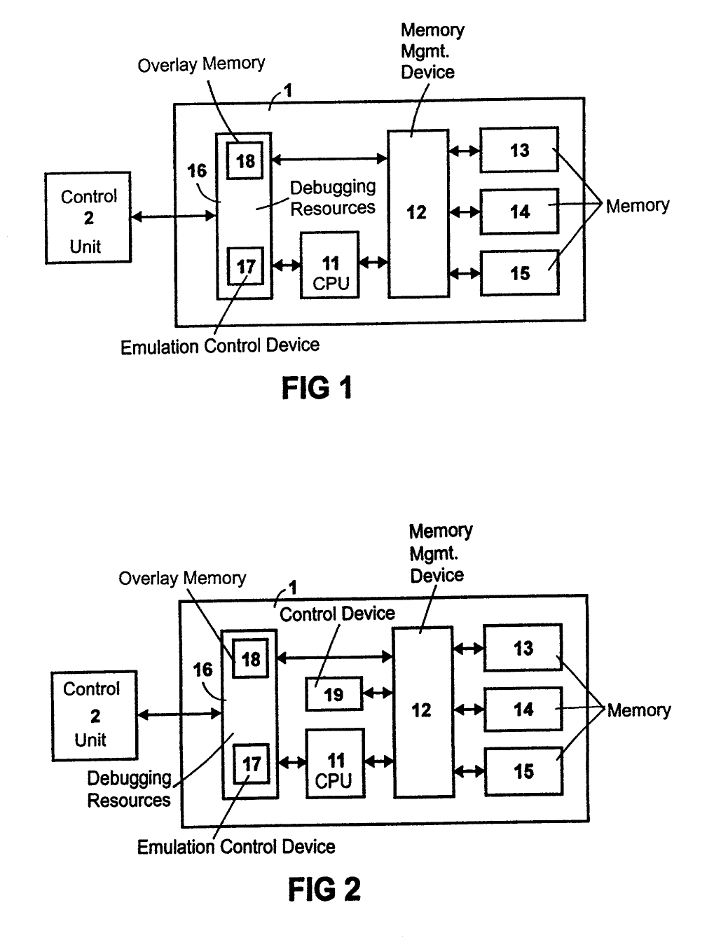

Referring now to the figures of the drawing in detail and first, particularly, to FIG. 1 thereof, there is shown an emulator. It shall already be pointed out at this juncture that only those components of the emulator that are of particular interest in the present case are illustrated by the configuration shown in FIG. 1.

The emulator contains a program-controlled unit 1, and a control unit 2 that controls the emulation.

The program-controlled unit 1 contains a CPU 11, a memory management device 12 connected to the CPU 11, memories 13 to 15 connected to the memory management device 12, and debugging resources 16 connected to the CPU 11, the memory management device 12 and the control unit 2.

In the example considered, the memories 13 to 15 are a RAM (memory 13), a ROM (memory 14), and a flash memory (memory 15).

The debugging resources 16 contain an emulation control device 17, an overlay memory 18, which can be written to by the control unit 2, and, if appropriate, further components such as, for example, a monitor memory, a trace memory, etc.

For the sake of completeness, it shall be noted that the program-controlled unit 1 can contain one or a plurality of semiconductor chips. In particular, the debugging resources 16 can (but need not) be accommodated on a dedicated semiconductor chip. Such a program-controlled unit is described in Published, Non-Prosecuted German Patent Application DE 197 432 64 A1.

In normal operation of the program-controlled unit, the CPU 11 executes a program stored in the flash memory 15, the access to the flash memory being affected by the memory management device 12 in the manner described in the introduction.

During the emulation of the program-controlled unit 1, the control unit 2 in interaction with the debugging resources 16 monitors the occurrence of predeterminable states or events, and reacts to the occurrence of the relevant state or event in a likewise predeterminable manner.

The predeterminable states or events consist, for example, in specific data, addresses or control signals being transferred or stored within or outside the program-controlled unit 1.

The predeterminable reactions to the occurrence of such or other states or events contain, for example, the stopping of the program-controlled unit 1, the read-out and/or the alteration of the contents of registers or internal and external memories and/or the recording and evaluation of the profiles—occurring beforehand and/or afterward—of data, addresses, signals of interest, and/or register and memory contents.

As a reaction to the occurrence of a specific state or event, but also independently of this, the control unit 2 can also cause the CPU 11 to use the overlay memory 18 contained in the debugging resources 16, instead of one of the memories 13 to 15. In the example considered, it shall be assumed that the overlay memory 18 is used instead of the flash memory 15. In this case, instead of the program stored in the flash memory 15, the CPU 11 would execute a program stored in the overlay memory 18 of the debugging resources 16. The changeover from the flash memory 15 to the overlay memory 18 is affected, as has already been mentioned above, by a change—instigated by the emulator—of assignments in the memory management device 12. The CPU 11 does not notice any of this. It outputs the same addresses as before and thinks that it obtains its program from the flash memory 15.

It should be apparent and needs no further explanation that replacing one memory by another memory offers diverse possibilities for identifying and localizing errors in the program-controlled unit 1, or in devices that cooperate with the program-controlled unit 1, or in the program executed by the program-controlled unit 1.

It is shown in practice, however, that the program-controlled unit 1 or a system containing the program-controlled unit 1 occasionally behaves differently during emulation than is the case in normal operation of the program-controlled unit 1. This is disturbing because it makes the identification and localization or errors more difficult or completely impossible.

The program-controlled unit 1 described below is a development of the program-controlled unit 1 shown in FIG. 1 and described with reference thereto; identical or mutually corresponding components are designated by the same reference symbols.

The program-controlled unit described and shown in FIG. 2 differs from the program-controlled unit shown in FIG. 1 by the fact that a control device 19 is provided. The control device 19 prescribes at least in part the instants at which the memory management device 12 has to perform the actions required for carrying out a data transfer.

In the example considered, the control device 19 is a separate unit in the program-controlled unit 1. However, it could also be a constituent part of the memory management device 12 or of any other component of the program-controlled unit 1.

The instants prescribed by the control device 19 will generally be the instants at which the memory management device 12 has to output an address to the memory device to be addressed, at which the memory management device 12 has to output control or handshake signals to the memory device or has to accept them from the memory device, at which the memory management device 12 has to output the data that are to be stored in the memory device to the memory device or at which the memory management device 12 has to fetch from the memory device the data that are to be read from the memory device, and/or at which the memory management device 12 forwards data read from the memory device to the CPU 11.

The instants of what actions the control device 19 prescribes depends, however, on the manner in which the memory management device 12 must communicate with the memory device in order to write data thereto or read data therefrom. In other words, the control device 19 can, in principle, prescribe as many instants as desired, and instigate any desired actions at the instants. If a plurality of memory devices (the memories 13 to 15 and the overlay memory 18) are connected, as in the example considered, the control device 19 can prescribe different instants depending on the memory device that is currently to be addressed.

In the example considered, “only” the access to the flash memory 15 and to the overlay memory 18 is of interest.

The accesses are controlled in such a way that the access to the flash memory 15 and the access to the overlay memory 18 take place exactly identically from the point of view of the CPU 11. In particular, the control device 19 ensures that data which are read from the overlay memory 18 are output to the CPU 11 by the memory management device 12 exactly at the instant as would be the case if the relevant data had been read from the flash memory 15.

The actions that must be executed by the memory management device 12 in order to write data to the respective memory devices, or in order to read data from the respective memory devices, and also the instants at which the individual actions are to be carried out depend on the memory devices used and may be different. In the example considered there are significant differences, because the overlay memory 18 is formed by a RAM in the present case. The fact of whether and, if appropriate, what differences are present here in the event of access to the flash memory 15 and to the overlay memory 18 is entirely unimportant for the CPU 11 and its behavior. The CPU 11 does not notice any of this because there are no differences either in the manner in which the CPU 11 instigates the memory access, or in the manner in which data read from a memory device are communicated to the CPU 11, or in the instants at which this is effected or in the time intervals between the individual operations.

As a result, in the case where the data transfers requested by the CPU 11 are affected from or to the overlay memory 18, the CPU 11 behaves in exactly the same way as would be the case if the requested data transfers were affected from or to the flash memory 15.

This also applies when the memory devices are accommodated on different chips, and/or when the memory devices must be accessed using different access mechanisms, and/or when one of the memory devices, for example the flash memory 15 is read from and/or written to via a pipeline, and the other memory device is read from and/or written to not via a pipeline or another pipeline.

What can thus be achieved is that, during the emulation of the program-controlled unit, the program-controlled unit and the system containing it behave in exactly the same way as is the case in normal operation.

It should be apparent and needs no further explanation that the control device 19 can also ensure that the RAM 13 and the overlay memory 18 and/or the ROM 14 and the overlay memory 18 and/or some other memory device and the overlay memory 18 behave identically from the point of view of the CPU 11.

The circumstance whereby the control device 19 prescribes the instants at which the memory management device 12 has to perform the actions required for carrying out a data transfer can also advantageously be used for other purposes. Specifically, this obviates at least in part the need for the memory management device 12 and the memory device that is intended to be accessed to carry out a handshake method. In particular, there is no need for the memory management device 12 to await and evaluate a ready signal by which the addressed memory device signals to it that the requested data can be fetched. Instead of this, the control device 19 can be set in such a way that it already instigates the beginning of the read-out before the occurrence of the ready signal, as a result of which the reading of the requested data can be begun more or less at the same time as the outputting of the ready signal by the memory device. What instant this is depends on the memory device used and can be set in the control device 19. Such a procedure makes it possible for the data requested from the memory device to be fetched from the memory device earlier than would be the case if the data were read out after the reception and evaluation of the ready signal.

The control device 19 also enables accesses to memory devices which succeed one another at maximum speed and in the case of which an address which is valid for the next access can already be output before the data requested in the previous access have been output or fetched. For this purpose, the control device 19 must “only” ensure that the addresses for the next access or for further accesses are output at the earliest possible point in time.

The provision of the control device 19 thus equally proves to be advantageous in multiple respects.

I claim:

1. A program-controlled unit, comprising:
a CPU;
a memory device;
a memory management device connected to said CPU and to said memory device, said memory management device at an instigation of said CPU, one of writes data output by said CPU to said memory device and reads out the data stored in said memory device and forwards the data to said CPU; and
a control device connected to said memory management device, said control device prescribes at least in part instants at which said memory management device has to perform actions required for carrying out a data transfer.

2. The program-controlled unit according to claim 1, wherein said control device prescribes an instant at which said memory management device can address said memory device again in an event of repeated accesses to said memory device.

3. The program-controlled unit according to claim 1, wherein said control device prescribes an instant at which said memory management device can output the data that are to be written to said memory device.

4. The program-controlled unit according to claim 1, wherein said control device prescribes an instant at which said memory management device can fetch previously requested data from said memory device.

5. The program-controlled unit according to claim 1, wherein said control device prescribes an instant at which said memory management device forwards the data read from said memory device to said CPU.

6. The program-controlled unit according to claim 5, wherein said memory management device forwards the data read from said memory device to said CPU at least in part not until at a later time than it could do.

7. The program-controlled unit according to claim 1, wherein the instants at which said memory management device has to the perform actions required for carrying out the data transfer are defined independently of control signals output by said memory device in order to signal that a specific action can now he executed.

8. The program-controlled unit according to claim 1, wherein said CPU informs said memory management device of a memory address to which a memory access that is to be carried out has to be effected.

9. The program-controlled unit according to claim 8, wherein said memory device is one of a plurality of memory devices connected to said memory management device, and said memory management device contains an assignment specification which defines, independently of an address fed to said memory management device by said CPU, which of said memory devices must be accessed by said memory management device.

10. The program-controlled unit according to claim 9, wherein the assignment specification is variable, so that said memory management device accesses a different one of said memory devices than is normally the case.

11. The program-controlled unit according to claim 10, wherein said different one of said memory devices is a memory device which has one of other properties and must be communicated with differently than is the case with a respective memory device normally used.

12. The program-controlled unit according to claim 10, wherein said control device ensures that, apart from a content of the data obtained, from a point of view of said CPU there is no difference in respect of whether a normally used memory device or said different one of said memory devices is accessed.

13. The program-controlled unit according to claim 12, wherein said control device ensures that the data read from said different one of said memory devices are forwarded to said CPU exactly at an instant as would be the case if the data had been read from said normally used memory device.

14. The program-controlled unit according to claim 10, further comprising an emulator control unit connected to the program-controlled unit, and the assignment specification is altered at an instigation of said emulator control unit.

15. The program-controlled unit according to claim 14, wherein said different one of said memory devices which is used instead of a normally used memory device in response to an alteration of the assignment specification is an overlay memory in which there is stored a program which is to be executed for emulation purposes instead of a program stored in said normally used program memory.
